(19) United States
(12) Patent Application Publication
(10) Pub. No.: US 2007/0157476 A1
(43) Pub. Date: Jul. 12, 2007

(54) Devices, blades, and uses thereof

(75) Inventor: Donald Hunt, Pride, LA (US)

Correspondence Address: Peter G. Carroll;MEDLEN & CARROLL, LLP, Suite 350, 101 Howrad Street, San Francisco, CA, 94105, US

(73) Assignee: ORCON CORPORATION

(21) Appl. No.: 11/329,657

(22) Filed: Jan. 11, 2006

(51) Int. Cl. B26B 9/02

(52) U.S. Cl. 30/355

(57) ABSTRACT

The invention relates to blades. In some embodiments, the invention relates to devices comprising blades disclosed herein. In some embodiments, the invention relates to the use of serrated blades to remove films from a surface. In further embodiments, the invention relates to the use of serrated blades and devices comprising said serrated blades to remove adhesives or films from a surface.

### FIELD OF INVENTION

The invention relates to blades. In some embodiments, the invention relates to devices comprising cutting implements, including blades and saws. In some embodiments, the invention relates to the use of serrated blades to remove films from a surface. In further embodiments, the invention relates to the use of serrated blades and devices comprising said serrated blades to remove adhesives or films from a surface.

### BACKGROUND

As the costs of building materials are significant, there is need to develop tools and methods for renovating existing buildings and recycling materials. Often when remodeling a building the existing floor will be replaced. When physical securing means such as nails are used the flooring may not have the esthetic appearance desired. Therefore, adhesives are preferred as a component used to secure flooring. As the flooring falls into disrepair, replacing the floor becomes necessary. Often, the most difficult task in replacing an existing floor comes not from the removal of the flooring itself, but in the removal of the adhesive used to secure the flooring. Instruments with blades may be used with blunt physical force to pry the adhesive from the surface. Thus, there is a need to identify instruments that can be used to improve the energy required to remove flooring adhesives from a surface.

### SUMMARY OF THE INVENTION

The invention relates to blades. In some embodiments, the invention relates to devices comprising cutting implements, including blades and saws. In some embodiments, the invention relates to the use of serrated blades to remove films from a surface. In further embodiments, the invention relates to the use of serrated blades and devices comprising said serrated blades to remove adhesives or films from a surface.

In some embodiments, the invention relates to a blade comprising a plurality of gaps along said blade edge configured to provide a plurality of narrowed edges wherein said plurality of edges are separated by a pair of mirrored convex arches connected by a circular bend.

In some embodiments, the invention relates to a blade comprising a plurality of gaps configured to provide a plurality of narrowed edges wherein said plurality of edges are separated by a pair of mirrored convex arches having a minimum distance between said convex arches connected by a circular bend having a maximum diameter wherein said minimum distance is less than said maximum diameter.

In some embodiments, the invention relates to devices comprising blades disclosed herein. In further embodiments, said devices are comprised of blades, handles, and mechanisms for securing said blades to said handles.

In some embodiments, the invention relates to a device comprising a least one narrowed edge comprising a plurality of gaps wherein each gap separated by a pair of mirrored convex arches connected by a circular bend. In further embodiments, said narrowed edge is a double beveled edge. In further embodiments, said narrowed edge is a single beveled edge. In further embodiments, said device is comprised of a plurality of said narrowed edges. In further embodiments, said plurality of narrowed edges comprises at least one single beveled edge. In further embodiments, said plurality of narrowed edges comprises at least one double beveled edge. In further embodiments, said plurality of narrowed edges are configure on said device such that they are mirror images of each other. In further embodiments, said plurality of narrowed edges are configured such that rotation of said device by a half turn provides a device of identical shape. In further embodiments, said plurality of narrowed edges are configured such that rotation of said device by a half turn provides a device of that is a mirror image shape.

In some embodiments, the invention relates to a device comprising a blade comprising a plurality of gaps configured to provide a plurality of narrowed edges wherein said plurality of edges are separated by a pair of mirrored convex arches connected by a circular bend. In further embodiments, said blade is double beveled. In further embodiments, said blade is a single beveled. In further embodiments, said blade comprises a beveled front edge and a beveled back edge. In further embodiments, said beveled front edge is narrowed on the front face and said beveled back edge is narrowed on said front face. In further embodiments, said blade comprises at least on closed gap. In further embodiments, said blade comprises a humped ridge. In further embodiments, said beveled front edge is narrowed on the opposite face that said beveled back edge is narrowed. In further embodiments, said blade comprises at least one closed gap. In further embodiments, said blade comprises a humped ridge.

In some embodiments the invention relates to a blade comprising a plurality of gaps configured to provide a plurality of narrowed edges wherein said plurality of edges are separated by a pair of mirrored convex arches connected by a circular bend.

In some embodiments the invention relates to a blade comprising a plurality of gaps configured to provide a plurality of narrowed edges wherein said plurality of edges are separated by a pair of mirrored convex arches separated by distance connected by a circular bend having a diameter wherein said distance is less than said diameter.

In some embodiments, the invention relates to a blade comprising a plurality of gaps configured to provide a plurality of narrowed edges wherein said plurality of edges are separated by a pair of mirrored convex arches separated by a minimum distance connected by a circular bend having a maximum diameter wherein said minimum distance is less than said maximum diameter.

In some embodiments, the invention relates to blades as disclosed in the figures.

In some embodiment, the invention relates to method of using the devices and blades disclosed herein.

In some embodiments, the invention relates to a method of removing an adhesive or film from a surface comprising: a) providing a blade disclosed herein and a surface comprising an adhesive, and b) pressing said blade with to said surface and c) moving said blade along the area of said surface.

In some embodiments, the invention relates to a method of removing an adhesive or film from a surface comprising: a) providing i) a blade comprising a plurality of gaps configured to provide a plurality of narrowed edges wherein said plurality of edges are separated by a pair of mirrored convex arches connected by a circular bend and ii) a surface comprising an adhesive, and b) pressing said blade with to said surface and c) moving said blade along the area of said surface.

In one embodiment, the present invention contemplates a method comprising a) providing i) a blade comprising a least two edges having a plurality of gaps along said blade edges configured to provide a plurality of narrowed edges wherein said plurality of edges are separated by a pair of mirrored convex arches connected by a circular bend wherein said plurality of narrowed edges are configured such that rotation of said device by a half turn provides a blade of identical shape and b) rotating said blade so as to provide a blade of identical shape. In further embodiments, a handle is provided and the further step of inserting and/or removing said blade from said handle before and/or after rotation of said blade.

### BRIEF DESCRIPTION OF THE DRAWINGS

FIG. 1 shows one embodiment of the invention where the serrated blade is viewed from the top.

FIG. 2 shows one embodiment of the invention from a top isometric view where the serrated blade has one double beveled edge.

FIG. 3 shows one embodiment of the invention from a top isometric view where the serrated blade has one single beveled edge.

FIG. 4 shows one embodiment of the invention from a top isometric view where the serrated blade has two double beveled edges.

FIG. 5 shows one embodiment of the invention from a top isometric view where the serrated blade has one single beveled edge and one double beveled edge.

FIG. 6 shows one embodiment of the invention from a top isometric view where the serrated blade has two single beveled edges in the same direction.

FIG. 7 shows one embodiment of the invention from a top isometric view where the serrated blade has two single beveled edges that are narrowed on opposite top and bottom surfaces.

FIG. 8 shows one embodiment of the invention from a top isometric view where the serrated blade has two single beveled edges that are narrowed on opposite top and bottom surfaces and a humped ridge for alternate blade capture in a scraping handle.

FIG. 9 shows one embodiment of the invention from a top isometric view where the serrated blade has two single beveled edges that are narrowed toward the same surface and a plurality of oval spaces for alternate blade capture in a scraping handle.

FIG. 10 shows the embodiment of FIG. 9 from a bottom view.

FIG. 11 shows one embodiment of the invention from a top isometric view where the serrated blade has two single beveled edges that are narrowed on opposite top and bottom surfaces and a plurality of first oval spaces and a plurality of second circular spaces for alternate blade capture in a scraping handle.

FIG. 12 shows the embodiment of FIG. 10 from a bottom view.

FIG. 13 show one embodiment of the invention from isometric view where the device is composed of components that secure a serrated blade to a handle.

### DETAILED DESCRIPTION OF THE INVENTION

The invention relates to blades. In some embodiments, the invention relates to devices comprising cutting implements, including blades and saws. In some embodiments, the invention relates to the use of serrated blades to remove films from a surface. In further embodiments, the invention relates to the use of serrated blades and devices comprising said serrated blades to remove adhesives or films from a surface.

“Adhesive” means a substance, such as paste or cement, that provides or promotes adhesion.

“Arches” are curved structural members spanning an opening.

“Blade” means the flat (or substantially flat) cutting part of a cutting implement or sharpened tool. The apex of the blade is the sharpened edge.

“Convex arches” are arches having a boundary that curves outward, and “convex arches connected by a circular bend,” in the context of certain embodiments, is a boundary with a pair of convex arches connected at the ends curving outward to a portion of a substantially circular boundary wherein the boundary of the circle bends away from the outward alignment of the convex arches.

“Double beveled blade” means the apex of the blade is angled at a slant from the front face and rear face to the apex of the blade.

“Film” means a covering or coating such as paint.

Within the context of certain embodiments, a “humped ridge” refers to a raised area having an unevenness or elevation on a boundary.

In the context of certain embodiments, “Mirrored convex arches connected by a circular bend” means that convex arches are connected by a circular bend wherein the boundary of the pair of convex arches reflect each other, i.e., as if looking in a mirror placed in front of one of the convex arches and duplicating what is seen of the boundary on the other side of the mirror (the second arch). Within the context of certain embodiments, “mirror images” refers to the image the boundary obtained by reflecting the boundary in a mirror so that the signs of one of the Cartesian coordinate of the boundary are reversed. Two boundaries form a mirror pair if one can be translated and rotated in such a way that the pair together possesses mirror symmetry, i.e. one is the mirror image of the other. One of the objects in a mirror pair is often called left-handed and the other one is called right-handed.

Within the contexts of certain embodiments, a blade that has a “narrowed edge” means a tapered edge than narrows to the apex of the blade.

An “apex” is the pointed end of an object, e.g., the sharpened edge or tip of a blade.

“Gap” refers to an opening in a solid structure or surface. Within the context of certain embodiments, a “plurality of gaps along said blade” means that the openings are along the apex of the blade such that the apex is not entirely a continuously connected narrowed edge. For example, by providing gaps at the edge of the blade one creates notches or teeth that are substantially aligned along the apex of the blade.

“Serrated blade” means a blade that is notched with teeth along the apex of the blade. For example, by providing gaps at the edge of the blade one creates notches or teeth that are substantially aligned along the apex of the blade.

A blade becomes dulled after repeated use. One may sharpen the blade. Alternatively, it is often desirable to create a blade that has two narrowed edges so that one is not inconvenienced with sharpening the blade at that particular time. Often blades are held in a handle. The handle prevents exposing the unused edge during use. When it is desired to switch the exposed blade, the blade is removed from the handle and rotated in a manner to expose the previously unexposed edge.

Within the context of certain embodiments, “rotation of said device by a half turn” refers to flipping the blade 180 degrees along a center of mass. For example, if one views a flattened surface of a blade, the bottom of the flatten surface is down and the top of the flattened surface is up. Turning the blade to view the bottom surface is rotation of the blade by a half turn.

“Single beveled blade” means the apex of the blade is angled at a slant from either (one or the other but not both) of the front face or rear face to the apex of the blade.

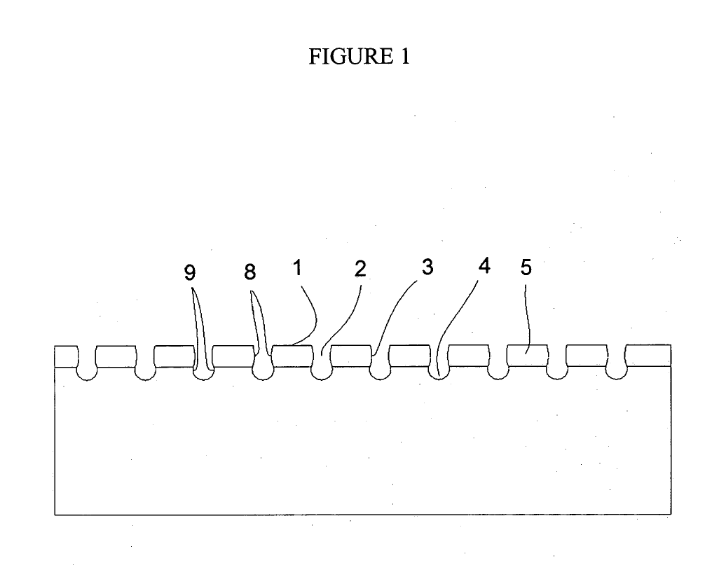

In one embodiment of the invention, as illustrated in FIG. 1, is a serrated blade comprising of a front of the blade (1) that becomes narrow to allow the edge of the blade to wedge itself between a surface and a substance on the surface. There is a plurality of gaps (2) along the edge of the blade. These gaps are comprised of a pair of convex arches (3) near the edge of the blade and the surface area near the edge of the blade (5) connecting an interior circular bend (4). In a preferred embodiment, the convex arches are configured such that viewed from the top of the blade the space in the gap between the mirrored convex arches (8) is narrower that the space in the gap or diameter (9) around the circular bend.

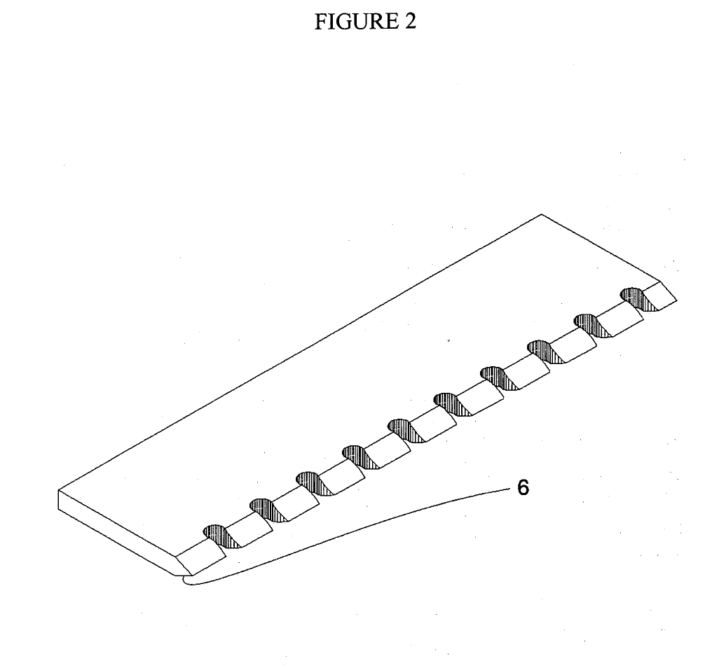

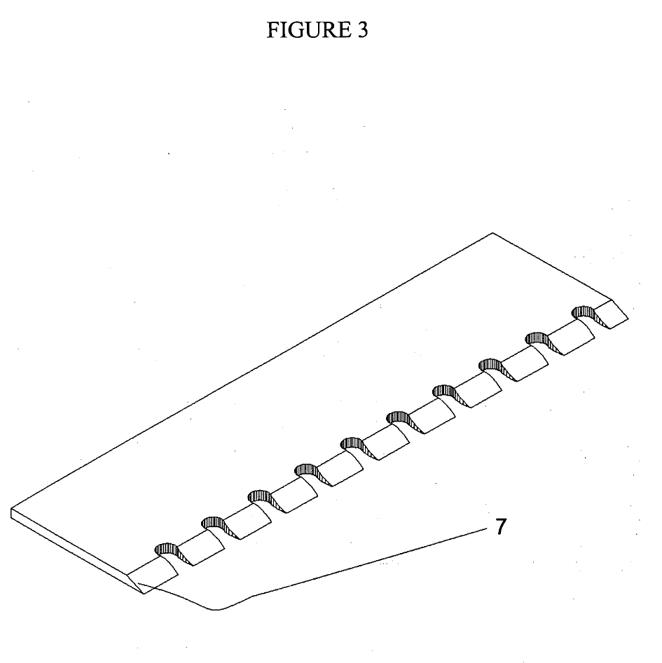

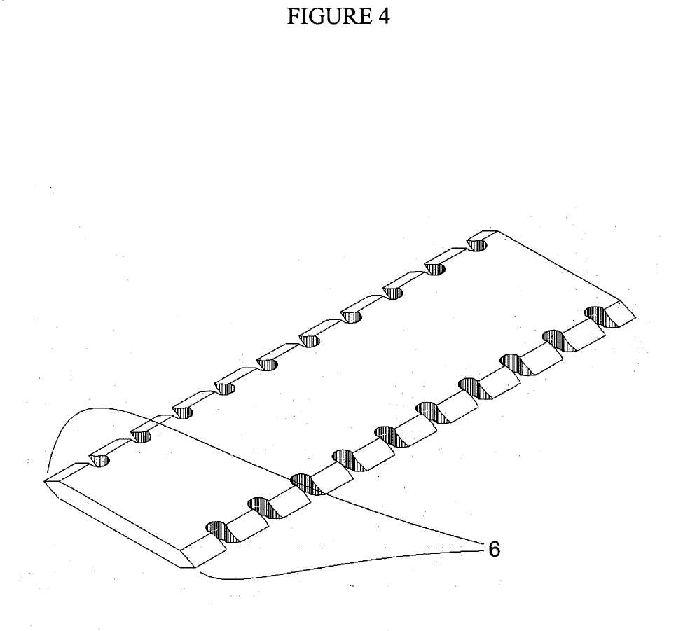

In one embodiment, as illustrated in FIG. 2 the serrated blade has one double beveled edge (6). In further embodiments, as illustrated in FIG. 3, the serrated blade has one single beveled edge (7). In further embodiment, as illustrated in FIG. 4, the serrated blade has two double beveled edges.

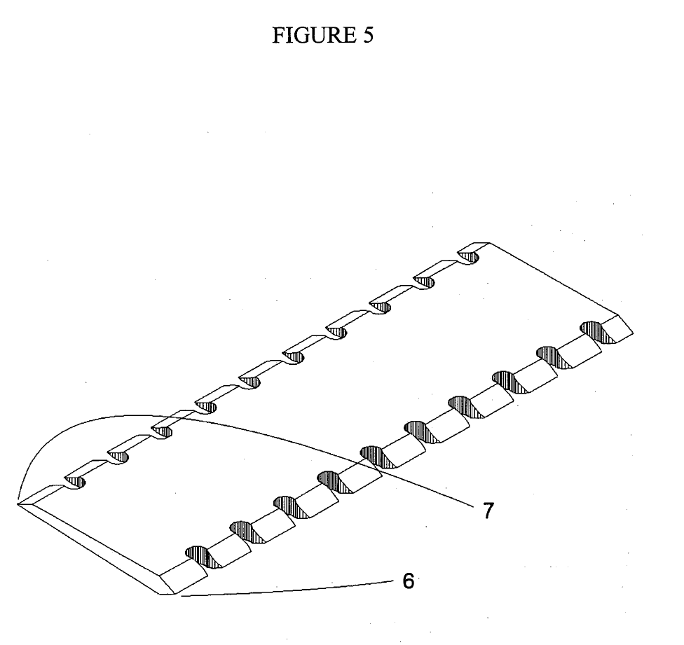

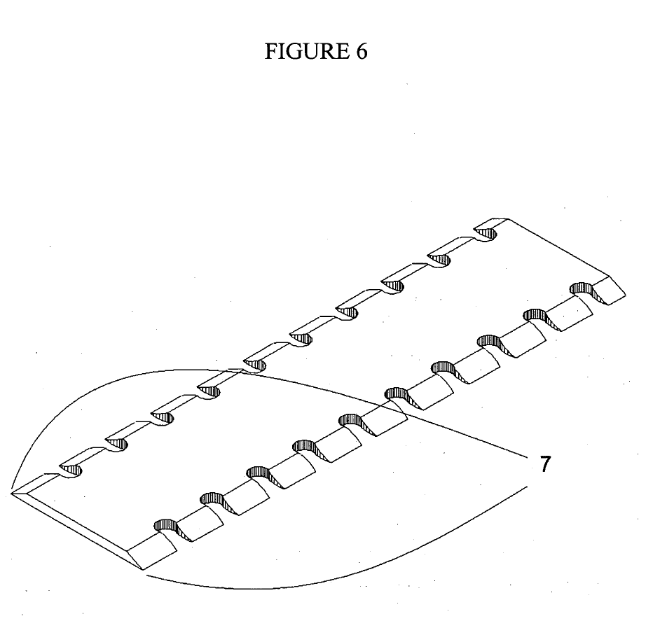

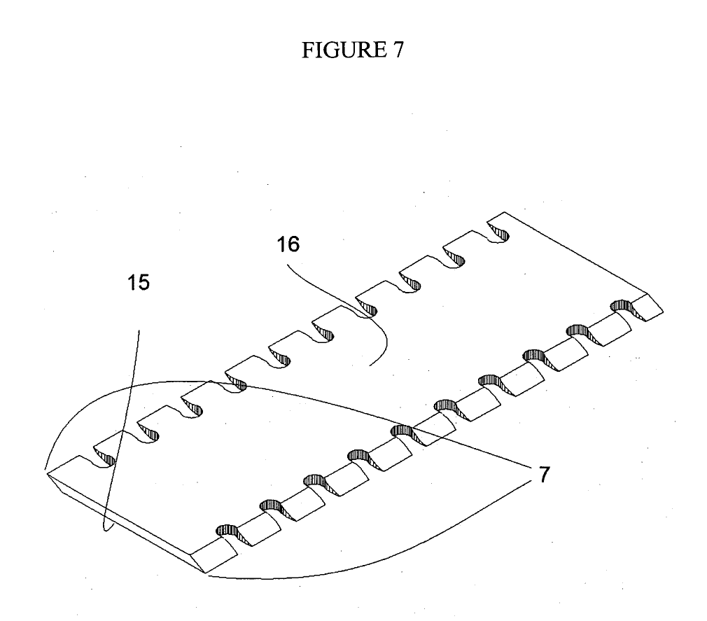

In some embodiments, as illustrated in FIG. 5, the serrated blade has one single beveled edge (7) and one double beveled edge (6). In further embodiments, as illustrated in FIG. 6, the serrated blade has two single beveled edges (7) in the same direction. In further embodiments, as illustrated in FIG. 7, the serrated blade has two single beveled edges (7) that are narrowed on opposite top (16) and bottom (15) surfaces.

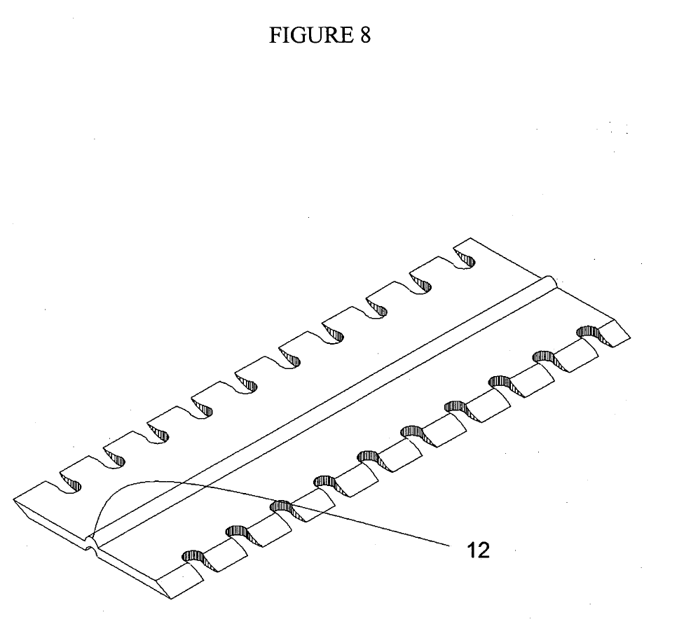

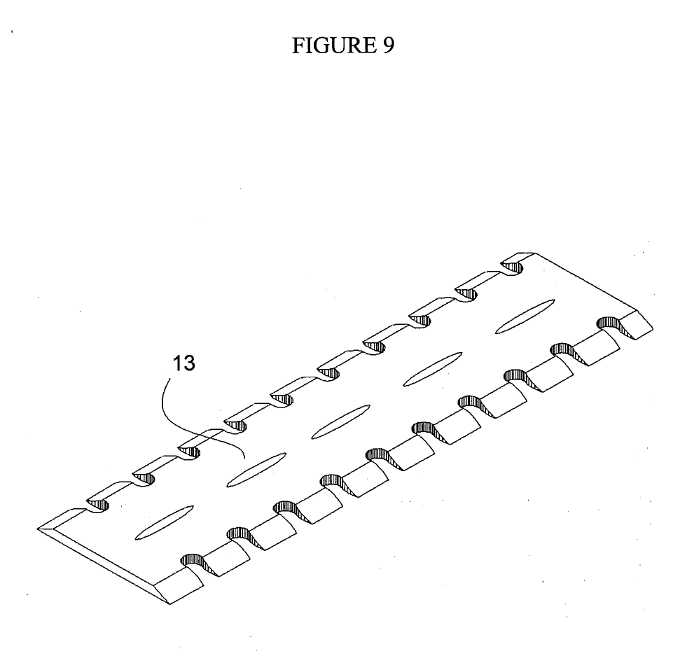

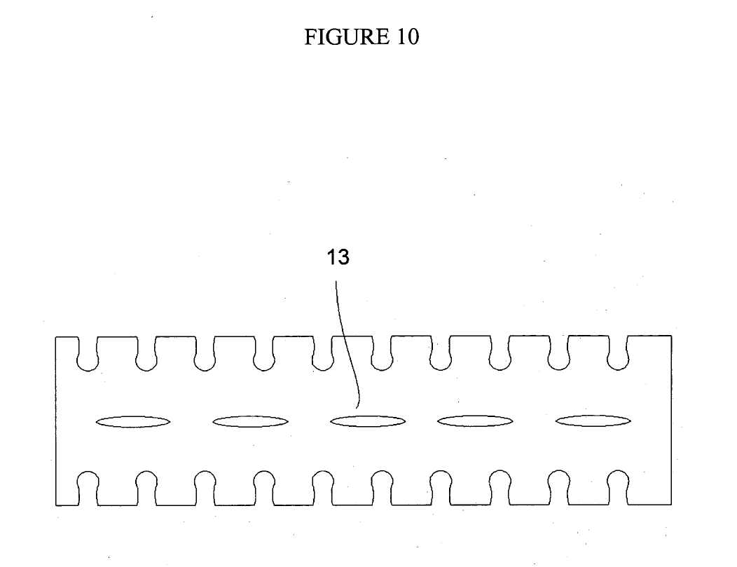

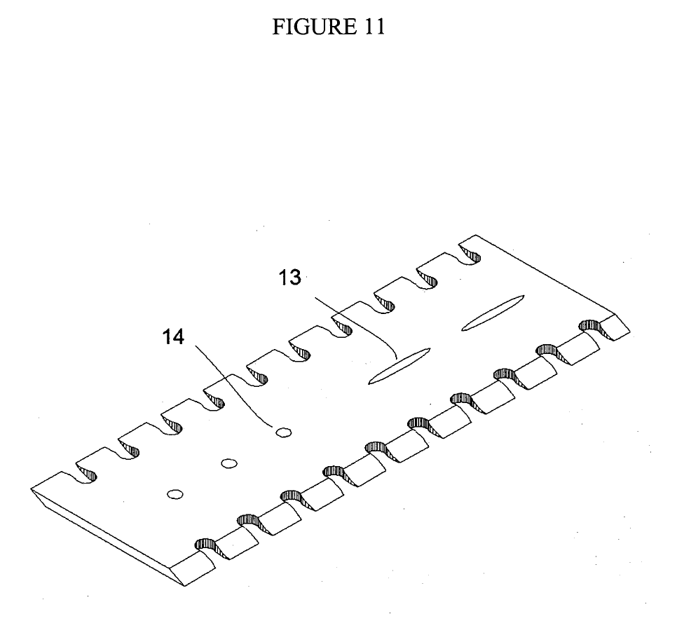

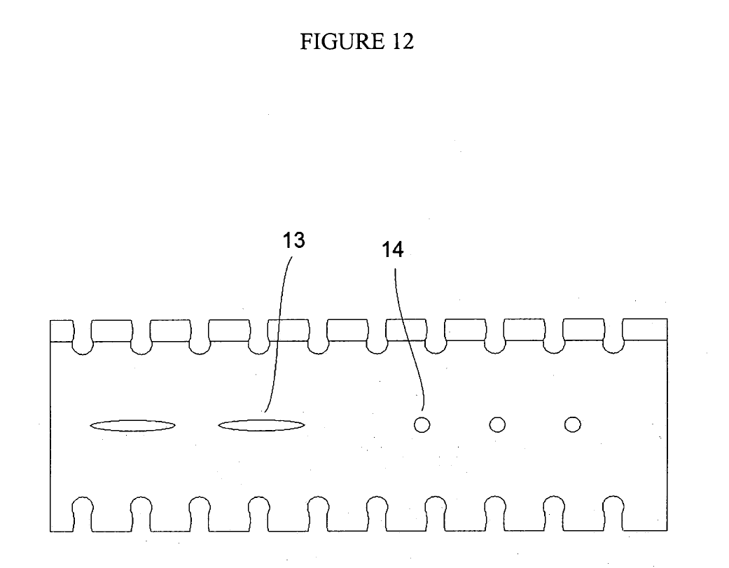

In further embodiments, as illustrated in FIG. 8, the serrated blade has two single beveled edges that are narrowed on opposite top and bottom surfaces and a humped ridge (12) for alternate blade capture in a scraping handle. In further embodiments, as illustrated in FIGS. 9 and 10, the serrated blade has two single beveled edges that are narrowed toward the same surface and a plurality of oval spaces (13) for alternate blade capture in a scraping handle. In further embodiments, as illustrated in FIGS. 11 and 12, the serrated blade has two single beveled edges that are narrowed on opposite top and bottom surfaces and a plurality of first oval spaces and a plurality of second circular spaces (14) for alternate blade capture in a scraping handle.

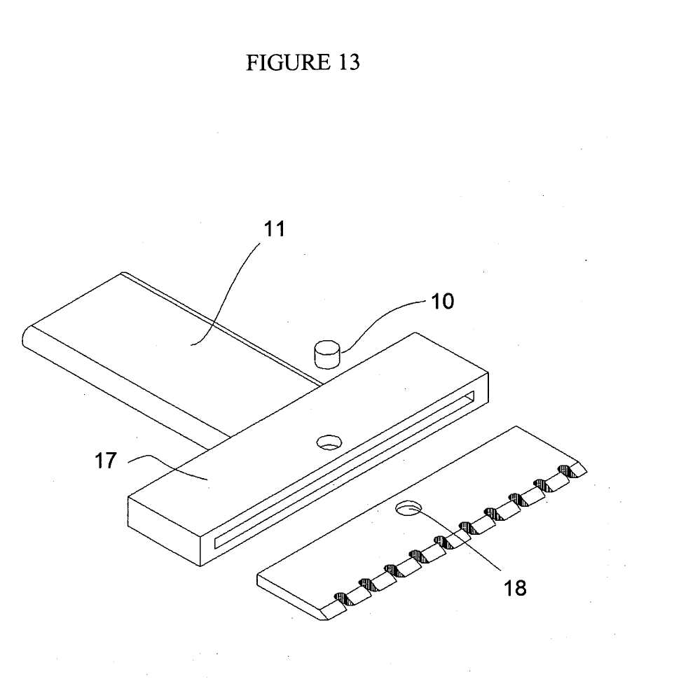

In some embodiments, as illustrated in FIG. 13, the devices of this invention are comprised of a serrated blade with a securing area (18) and a securing mechanism (10) and a handle (11). The securing mechanism allows the blade to be secured into the handle. This can be accomplished by a variety of ways well known to those skilled in the art. The securing mechanism may be a pin that is slightly larger than the area inside the handle. Thus, the pin may be squeezed into the housing area (17). Alternatively, the pin may be slightly smaller than the housing area, but after joined in place the pin is exposed to a substance that causes it to expand, e.g., wooden pin exposed to steam. The securing mechanism, handle, and blade may all be made of plastic; thus, joined by glue or epoxy or fuse together by heat or other chemical method. The blades and devices disclosed herein may be made of any material such as, but not limited to metals, plastics, ceramics, and woods.

In some embodiments, the invention relates to a blade comprising a plurality of gaps along said blade configured to provide a plurality of narrowed edges wherein said plurality of edges are separated by a pair of mirrored convex arches connected by a circular bend.

In some embodiments, the invention relates to a blade comprising a plurality of gaps configured to provide a plurality of narrowed edges wherein said plurality of edges are separated by a pair of mirrored convex arches having a minimum distance between said convex arches connected by a circular bend having a maximum diameter wherein said minimum distance is less than said maximum diameter.

In some embodiments, the invention relates to devices comprising blades disclosed herein. In further embodiments, said devices are comprised of blades, handles, and mechanisms for securing said blades to said handles.

In some embodiments, the invention relates to a device comprising a least one narrowed edge comprising a plurality of gaps wherein each gap separated by a pair of mirrored convex arches (8) connected by a circular bend (9) (see FIG. 1). In further embodiments, said narrowed edge is a double beveled edge. In further embodiments, said narrowed edge is a single beveled edge. In further embodiments, said device is comprised of a plurality of said narrowed edges. In further embodiments, said plurality of narrowed edges comprises at least one single beveled edge. In further embodiments, said plurality of narrowed edges comprises at least one double beveled edge. In further embodiments, said plurality of narrowed edges are configure on said device such that they are mirror images of each other. In further embodiments, said plurality of narrowed edges are configured such that rotation of said device by a half turn provides a device of identical shape. In further embodiments, said plurality of narrowed edges are configured such that rotation of said device by a half turn provides a device of that is a mirror image shape.

In some embodiments, the invention relates to a device comprising a blade comprising a plurality of gaps configured to provide a plurality of narrowed edges wherein said plurality of edges are separated by a pair of mirrored convex arches connected by a circular bend. In further embodiments, said blade is double beveled. In further embodiments, said blade is a single beveled. In further embodiments, said blade comprises a beveled front edge and a beveled back edge. In further embodiments, said beveled front edge is narrowed on the front face and said beveled back edge is narrowed on said front face. In further embodiments, said blade comprises at least on closed gap. In further embodiments, said blade comprises a humped ridge. In further embodiments, said beveled front edge is narrowed on the opposite face that said beveled back edge is narrowed. In further embodiments, said blade comprises at least one closed gap. In further embodiments, said blade comprises a humped ridge.

In some embodiments the invention relates to a blade comprising a plurality of gaps configured to provide a plurality of narrowed edges wherein said plurality of edges are separated by a pair of mirrored convex arches connected by a circular bend.

In some embodiments the invention relates to a blade comprising a plurality of gaps configured to provide a plurality of narrowed edges wherein said plurality of edges are separated by a pair of mirrored convex arches separated by distance connected by a circular bend having a diameter wherein said distance is less than said diameter.

In some embodiments, the invention relates to a blade comprising a plurality of gaps configured to provide a plurality of narrowed edges wherein said plurality of edges are separated by a pair of mirrored convex arches separated by a minimum distance connected by a circular bend having a maximum diameter wherein said minimum distance is less than said maximum diameter.

In some embodiments, the invention relates to blades as disclosed in the figures.

In some embodiment, the invention relates to method of using the devices and blades disclosed herein.

In some embodiments, the invention relates to a method of removing an adhesive from a surface comprising: a) providing a blade disclosed herein and a surface comprising an adhesive, and b) pressing said blade with to said surface and c) moving said blade along the area of said surface.

In some embodiments, the invention relates to a method of removing an adhesive from a surface comprising: a) providing i) a blade comprising a plurality of gaps configured to provide a plurality of narrowed edges wherein said plurality of edges are separated by a pair of mirrored convex arches connected by a circular bend and ii) a surface comprising an adhesive, and b) pressing said blade with to said surface and c) moving said blade along the area of said surface.

I claim:

1. A blade comprising a plurality of gaps along said blade configured to provide a plurality of narrowed edges wherein said plurality of edges are separated by mirrored convex arches connected by a bend.

2. A device comprising a least one narrowed edge comprising a plurality of gaps wherein each gap separated by mirrored convex arches connected by a bend.

3. The device in claim 2, wherein said narrowed edge is a double beveled edge.

4. The device in claim 2, wherein said narrowed edge is a single beveled edge.

5. The device in claim 2, wherein said devices is comprised of a plurality of said narrowed edges.

6. The device in claim 3, wherein said plurality of narrowed edges comprises at least one single beveled edge.

7. The device in claim 3 wherein said plurality of narrowed edges comprises at least one double beveled edge.

8. The device in claim 5, wherein said plurality of narrowed edges are configure on said device such that they are mirror images of each other.

9. The device in claim 5, wherein said plurality of narrowed edges are configured such that rotation of said device by a half turn provides a device of identical shape.

10. The device in claim 5, wherein said plurality of narrowed edges are configured such that rotation of said device by a half turn provides a device of that is a mirror image shape.

11. The device in claim 2, wherein said bend is a circular bend.

12. A blade comprising a plurality of gaps configured to provide a plurality of narrowed edges wherein said plurality of edges are separated by mirrored convex arches having a minimum distance between said convex arches connected by a circular bend having a maximum diameter wherein said minimum distance is less than said maximum diameter.

13. The device in claim 12, wherein said blade is double beveled.

14. The device in claim 12, wherein said blade is a single beveled.

15. The device in claim 12, wherein said blade comprises a beveled front edge and a beveled back edge.

16. The device in claim 15, wherein said beveled front edge is narrowed on the front face and said beveled back edge is narrowed on said front face.

17. The device in claim 16, wherein said blade comprises at least on closed gap.

18. The device in claim 16, wherein said blade comprises a humped ridge.

19. The device in claim 15, wherein said beveled front edge is narrowed on the opposite face that said beveled back edge is narrowed.

20. The device in claim 19, wherein said blade comprises at least one closed gap.
